(19) United States
(12) Patent Application Publication
(10) Pub. No.: US 2026/0201636 A1
(43) Pub. Date: Jul. 16, 2026

(54) COMPOSITIONS AND METHOD OF MAKING PH INDICATING NONWOVEN MATERIAL AND ABSORBENT PAD

(71) Applicant: KAS PET, LLC, Syosset, NY (US)

(72) Inventors: Melissa CHRISTENSON, Syosset, NY (US); Lindsay JOYCE, Syosset, NY (US)

(73) Assignee: KAS PET, LLC, Syosset, NY (US)

(21) Appl. No.: 19/025,064

(22) Filed: Jan. 16, 2025

(51) Int. Cl. D06P 1/00; A01K 1/015; A01K 29/00; B32B 5/02; B32B 29/02; B32B 38/08; C09D 5/02; C09D 5/29; C09D 7/20; C09D 7/45; C09D 7/63; C09D 131/04; D06P 1/52; D06P 1/62; D06P 1/92; D06P 3/82

(52) U.S. Cl. CPC D06P 1/004; A01K 1/0157; A01K 29/005; B32B 5/022; B32B 29/02; B32B 38/08; C09D 5/022; C09D 5/027; C09D 5/028; C09D 5/29; C09D 7/20; C09D 7/45; C09D 7/63; C09D 131/04; D06P 1/5221; D06P 1/5228; D06P 1/622; D06P 1/908; D06P 1/928; B32B 2260/021; B32B 2260/046; B32B 2262/0253; B32B 2305/28; B32B 2307/726; B32B 2317/12; B32B 2323/04; B32B 2555/02; D06P 3/8285

(57) ABSTRACT

A method of manufacturing and compositions required to produce a pH indicating absorbent pad. The method includes preparing a pH indicating dye composition, preparing a binder composition containing an emulsion polymer and surfactant and a pH indicating dye composition, then at least partially immersing or otherwise saturating nonwoven fibers, including at least some cellulose or cellulose-derived fibers, into the pH indicating binder composition, producing a pH indicating nonwoven material. The method further includes bonding the pH indicating nonwoven material to an absorbent core to produce the pH indicating absorbent pad.

### FIELD OF THE DISCLOSURE

The present disclosure relates to absorbent products designed for use with pets, particularly dogs, to monitor their health through urine analysis. Specifically, the disclosure pertains to absorbent pads and diaper liners that incorporate pH-indicating elements to visually signal variations in the pH of urine. Products embodying the subject technology aim to provide pet owners with a convenient and accessible way to assess their pet's health, including monitoring the effects of lifestyle, diet, or medications and detecting potential health issues such as infections or diseases.

### BACKGROUND

Monitoring a pet's health often requires specialized equipment or veterinary intervention, which can be inconvenient or costly for pet owners. Absorbent products that incorporate health-monitoring functionalities provide a practical alternative by leveraging daily pet care routines.

U.S. Pat. No. 10,660,301 describes cat litter containing an additive, e.g., a chemical agent, such as a natural and/or synthetic agent, that changes in color when it comes in contact with cat urine or feces. Based on the color, it can be determined whether the cat has a medical condition, such as particular illness. For example, if the litter turns yellow when it comes in contact with the urine, it can indicate that the cat is healthy. If the litter turns to a color other than yellow, e.g., green, it can indicate that the cat has some illness. The cat can then be taken to a veterinary doctor for further diagnosis. The chemical agent aids in detection and diagnosis through interaction of materials that change colors to indicate reactions with specific chemicals, cells, molecules, DNA and/or materials.

U.S. Pat. No. 8,061,292 B2 discloses a wetness indicating composition that changes color in response to a change in pH. The composition comprises a water-insoluble, thermoplastic polymer composition, a superabsorbent polymer, a wetness indicator, and surfactant. The wetness indicating composition is applicable in disposable absorbent articles, e.g., disposable diapers, feminine napkins, medical dressings and beddings for humans and animals.

There remains a need for absorbent products specifically tailored for pets that provide clearer visual indications of pH changes, particularly in scenarios where alkaline urine could signal potential health concerns. Existing absorbent pads and liners designed for pets often prioritize basic containment functions without integrating advanced health-monitoring features. Pet owners could benefit from products that not only fulfill their primary purpose but also provide insight into their pet's health through intuitive and immediate visual feedback. This would allow for proactive management of health concerns and foster improved communication with veterinary professionals.

Further, there are significant problems and challenges that must be overcome in order to incorporate pH indicating dyes into absorbent products to create commercially-viable pad products. These problems and challenges include 1) dye bleed and/or transfer of dyes onto skin, or into the pad absorbent core, after liquid insult, 2) neutralization of the pH indicating dye color shift in alkaline state when dye is drawn into acidic sodium polyacrylate SAP polymer, which is used to contain urine in the absorbent core of absorbent products, 3) neutralization of the color shift due to ionic interactions between the pH indicating dyes and other chemical additives or materials used in the pad, 4) limited options for pH indicating dyes that transition at the required pH of 7.5, 5) high cost of pH indicating dyes compared to other water-soluble dyes, and 6) inappropriate color shift for the most preferred pH indicating dye, phenol red, which changes from yellow (acidic pH 7 and below) to red (alkaline pH 7.5 and above). Thus, there remains a need for novel pH indicating chemical compositions, materials, and methods of manufacturing to incorporate pH indicators into commercially-viable and consumer acceptable absorbent products.

### SUMMARY

Embodiments of the subject technology include a method of manufacturing a pH indicating absorbent pad. The method includes 1) preparation of a water-soluble pH indicating dye composition and incorporating it into a water-based binder composition which contains at least one emulsion polymer, and at least one surfactant 2) manufacture of the pH indicating nonwoven by at least partially immersing or otherwise saturating nonwoven fibers, including at least some amount of cellulose or cellulose-derived material such as rayon, and at least some amount of synthetic fibers such as polyethylene, into the pH indicating binder. Excess binder is removed from the saturated fibers through pressure and heat drying. producing a pH indicating nonwoven material. 3) Finally, the pH indicating nonwoven material is bonded on top of an absorbent core with a bottom layer hydrophopic back sheet to produce the pH indicating absorbent pad.

In some embodiments, the pH indicating dye composition may include 2% by weight Phenol Red dye and 2% by weight Acid Green 16 dye. Further, the pH indicating dye composition may include 18% by weight isopropyl alcohol and 78% by weight water.

In some embodiments, the pH indicating binder bath composition may include a nonionic or anionic emulsion polymer such as vinyl acetate ethylene (Celanese Dur-o-Set® Elite 22) and a nonionic or anionic surfactant such as sodium dioctylsulfosuccinate (Dow Polywet® 700-D). Further, the pH indicating binder bath composition may include 0.31% by weight Dow Polywet 700-D, 23.64% by weight Celanese Dur-o-Set Elite 22, 75% by weight water 0.1 % by weight ammonium chloride, and 0.95% of a 4% active pH indicating dye composition

In some embodiments, the nonwoven fabric may include at least some amount of cellulose or cellulose-derived fibers and at least some amount of synthetic fibers. Further, the nonwoven fabric may include 50% rayon and 50% polyethylene fibers.

Embodiments of the subject technology include a method of manufacturing a pH indicating nonwoven material. The method includes the steps of preparing a pH indicating dye composition then incorporating it into a binder composition which contains at least one anionic or nonionic emulsion polymer, and at least one anionic or nonionic surfactant. The resulting pH indicating binder composition is then a used to saturate and bond nonwoven fibers containing at least some cellulose or cellulose-derived fibers, producing a pH indicating nonwoven material.

In some embodiments, the binder composition may include 0.31% by weight of Dow Polywet 700-D, a 70% active solution of sodium dioctylsulfosuccinate in diethylene glycol, and 23.64% by weight of Celanese Dur-o-Set Elite 22, a 50% active solution of vinyl acetate ethylene in water. Further, the binder composition may include 0.95% of a pH indicating dye composition which contains 2% active Phenol Red and 2% active Acid Green 16 dyes in solvents of water and isopropyl alcohol.

Embodiments of the subject technology include a method of manufacturing a pH indicating absorbent pad. The method includes the steps of preparing a pH indicating dye composition, preparing a binder composition containing a nonionic or anionic emulsion polymer, a nonionic or anionic surfactant, and the pH indicating dye composition containing at least one water soluble pH indicating dye and at least one additional water-soluble dye. The method includes at least partially immersing or otherwise saturating a nonwoven fibers or blends of fibers containing at least some amount of cellulose or cellulose-derived fibers such as rayon and at least some amount of synthetic fibers such as polyethylene into the binder composition, producing a pH indicating nonwoven material, then bonding the pH indicating nonwoven material to the top of an absorbent core containing at least some cellulose pulp and a sodium polyacrylate superabsorbent polymer with hydrophobic bottom layer to produce the pH indicating absorbent pad.

In some embodiments, the method may include bonding the pH indicating nonwoven material to the top of an absorbent core that includes at least one tissue layer on the top and/or bottom of the core, and a hydrophobic backsheet layer to produce the pH indicating absorbent pad.

### BRIEF DESCRIPTION OF THE DRAWINGS

Various aspects of the present disclosure are discussed herein with reference to the accompanying Figures. It will be appreciated that for simplicity and clarity of illustration, elements shown in the drawings have not necessarily been drawn accurately or to scale. For example, the dimensions of some of the elements can be exaggerated relative to other elements for clarity or several physical components can be included in one functional block or element. Further, where considered appropriate, reference numerals can be repeated among the drawings to indicate corresponding or analogous elements. For purposes of clarity, however, not every component can be labeled in every drawing. The Figures are provided for the purposes of illustration and explanation and are not intended as a definition of the limits of the disclosure.

FIG. 1A is a top, plan view of a pH indicating absorbent pad, in accordance with the subject technology.

FIG. 1B is a cross-sectional, plan view of the pH indicating absorbent pad of FIG. 1A.

FIG. 2 is flow chart detailing a method of manufacturing the pH indicating absorbent pad of FIGS. 1A-1B, in accordance with the subject technology.

### DETAILED DESCRIPTION

The subject technology overcomes many of the prior art problems associated with absorbent products that incorporate health-monitoring functionalities. The advantages, and other features of the technology disclosed herein, will become more readily apparent to those having ordinary skill in the art from the following detailed description of certain exemplary embodiments taken in combination with the drawings and wherein like reference numerals identify similar structural elements. It should be noted that directional indications such as vertical, horizontal, upward, downward, right, left and the like, are used with respect to the figures and not meant in a limiting manner.

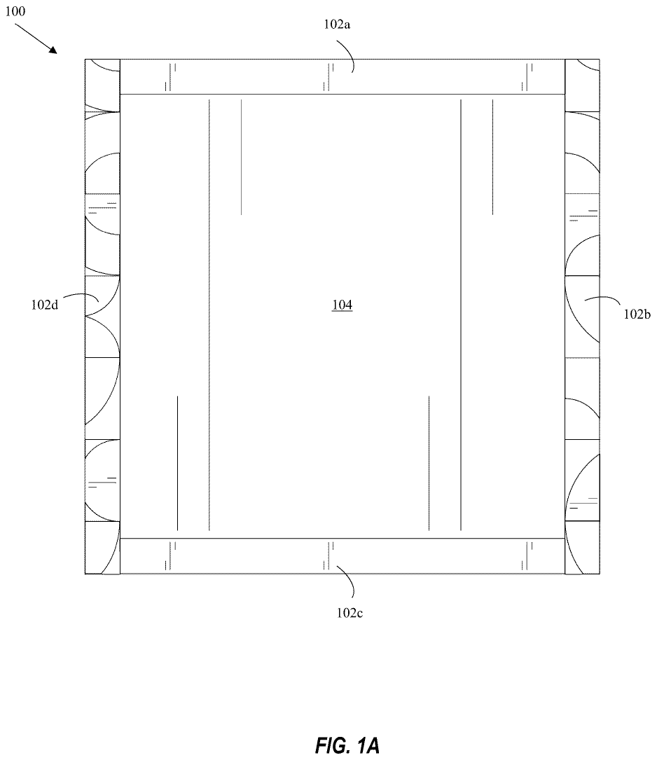

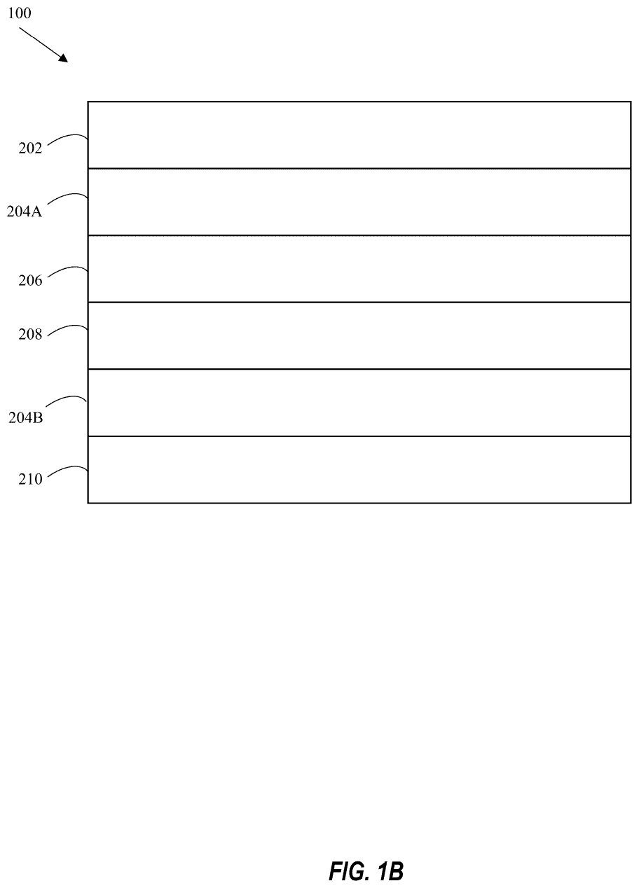

Referring now to FIG. 1A, a pH indicating absorbent pad 100 is shown in a top, plan view. The pH indicating absorbent pad 100 is generally rectangular, with dimensions tailored for use in various applications, including different sizes of pets. The pad features four delineated perimeter edges 102a-d that define the bounds of the pad 100. The edges 102a-d may be either colored or textured to contrast with a central portion 104 of the pad 100 to aid in both aesthetic appeal and functionality, such as guiding an animal towards the central portion 104. However, the edges 102a-d may also be omitted from the pH indicating absorbent pad 100. Furthermore, the pH indicating absorbent pad 100 may include printed designs or branding elements, such as logos, paw prints, or decorative motifs as desired.

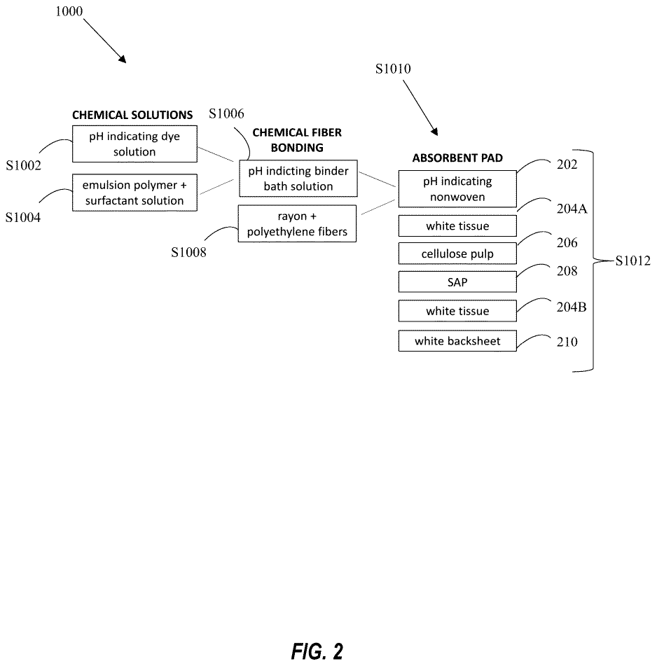

Referring now to FIG. 1B the pH indicating absorbent pad 100 is shown in a cross-sectional, plan view. The top layer is a hydrophilic, pH indicating non-woven layer 202, the composition and method of chemical binding manufacture of which is described below with reference to FIG. 2. The pH indicating non-woven layer 202 is further contemplated below with reference to FIG. 2.

Underneath the pH indicating nonwoven layer 202 is a low porosity tissue layer 204A. In one or more embodiments, the tissue layer 204A includes one or more plies of tissue. Low porosity tissue is further described in U.S. Pat. Nos. 3,837,996 and 4,522,863, both of which are hereby incorporated by reference. The tissue layer 204A may provide some liquid absorbency and may contribute to the strength and structure of the pH indicating absorbent pad 100.

Layer 206 is a cellulose pulp layer 206 serving to wick moisture into the absorbent core. The cellulose pulp layer 206 is constructed primarily from cellulose fibers, which may be derived from natural sources such as sustainably harvested wood or bamboo. In some configurations, the cellulose pulp may be blended with synthetic fibers to enhance durability and prevent clumping under heavy liquid exposure.

To ensure stability and durability, the cellulose fibers of the cellulose pulp layer 206 may be mechanically bonded, intertwined to reduce the risk of migration or clumping. In some cases, light adhesives are used to maintain the integrity of the layer during manufacturing and throughout the pad's usage. These bonding techniques ensure the cellulose pulp layer 206 remains intact, even under significant stress.

Structurally, the pulp layer 206 can be processed into various forms to meet specific functional requirements. A loose, fluffed pulp design allows for a highly porous and absorbent structure, creating void spaces that accommodate significant liquid volumes. Alternatively, the pulp can be compressed into a denser layer, offering increased strength and resistance to deformation while maintaining adequate absorption capacity. In some designs, the cellulose pulp layer 206 is arranged as multiple thin sub-layers to enable staged absorption. This layering technique ensures that liquid is absorbed progressively, preventing surface saturation and improving overall efficiency.

To enhance performance, the cellulose pulp layer 206 may be treated with various additives. Antimicrobial agents can be incorporated to inhibit bacterial growth and reduce odors, while odor-neutralizing compounds, such as activated carbon or baking soda, can be added to further minimize unpleasant smells.

Following the cellulose pulp layer 206 is a superabsorbent polymer (SAP) layer 208. The cellulose pulp layer 206 and the SAP layer 208, together or separately, may be referred to herein as an absorbent core. Sometimes being referred to as slush powder, superabsorbent polymers are those that can absorb and retain extremely large amounts of a liquid relative to their own mass. Water-absorbing polymers, which are classified as hydrogels when cross-linked, absorb aqueous solutions through hydrogen bonding with water molecules. Thus, the ability of the SAP layer 208 to absorb water is a factor of the ionic concentration of the aqueous solution. In deionized and distilled water, the SAP layer 208 may absorb 300 times its weight (from 30 to 60 times its own volume) and can become up to 99.9% liquid, but when put into a 0.9% saline solution, the absorbency drops to approximately 50 times its weight. The presence of valence cations in the solution impedes the polymer's ability to bond with the water molecule.

The total absorbency and swelling capacity of the SAP layer 208 is controlled by the type and degree of cross-linkers used in its production. A low-density cross-linked SAP layer 208 generally has a higher absorbent capacity and swells to a larger degree. These types of SAP layers 208 also have a softer and stickier gel formation. A high-density cross-link SAP layer 208 exhibits lower absorbent capacity and swell, but the gel strength is firmer and can maintain particle shape even under modest pressure.

The SAP layer 208 can be made from the polymerization of acrylic acid blended with sodium hydroxide in the presence of an initiator to form a poly-acrylic acid sodium salt (sometimes referred to as sodium polyacrylate). Other materials can also be used to make the SAP layer 208, such as polyacrylamide copolymer, ethylene maleic anhydride copolymer, cross-linked carboxymethylcellulose, polyvinyl alcohol copolymers, cross-linked polyethylene oxide, and starch grafted copolymer of polyacrylonitrile to name a few.

A second tissue layer 204b follows the SAP layer 208, similar in composition to the first tissue layer 204a. This secondary tissue layer 204b acts as a barrier, containing the SAP of the SAP layer 208 and any absorbed liquid while allowing residual liquid to flow downward toward the bottommost backsheet layer 210.

The backsheet layer 210 is a non-porous material derived from a durable, liquid-impermeable material such as polyethylene film. The backsheet layer 210 prevents any absorbed liquid from seeping through the pad and onto the surface below. Further, the backsheet layer 210 is typically smooth and features a slightly glossy finish, and may include textured elements, adhesive, or embossing to enhance grip and prevent the pH indicating absorbent pad 100 from sliding during use.

Each layer 202, 202a, 206, 208, 204b, 210 of the pH indicating absorbent pad 100 may be bonded together in a stack according to various assembly techniques including traditional needle and thread sewing, ultrasonic sealing, heat sealing, such as quilting with heat and pressure, hot-air welding, impulse welding, and radio-frequency welding. In one or more embodiments, hot-melt adhesive may be employed.

Turning now to FIG. 2, a method of manufacturing 1000 the aforementioned pH indicating nonwoven layer 202 is contemplated. The method 1000 optimizes the incorporation of pH indicating dye into a nonwoven fabric. The method 1000 utilizes a combination of natural cellulose fibers and polyethylene fibers that are blended and subsequently chemically bonded together using a binder composition that contains at least one water-soluble pH indicating dye in conjunction with at least one other water-soluble dye to create a distinct color change upon alkaline liquid insult. The type, porosity, and ionic nature of fibers, the chemical structure, ionic nature, and pH of binders, surfactants and other chemicals used in the binder composition, and the chemical structure and solubility of pH indicating dyes and other dyes used in the binder composition greatly impacts the strength of the dye-fiber bond, the stability of the color, the color transition from acidic to alkaline pH, the speed of the color transition, and the amount of bleed or dye transfer upon liquid insult to the pH indicating nonwoven material.

Further, surprisingly, the method 1000 enables the use of acidic SAP in a pH indicating absorbent pad using Phenol Red due to the creation of optimal dye-fiber bond strength in the pH indicating nonwoven, which prevents significant dye bleed upon liquid insult, yet still allows the pH indicating Phenol Red dye to change color due to the acid base reaction. Alternatively, a weak dye-fiber bond quickly releases the pH indicating dye upon liquid insult, resulting in a high degree of dye bleed into the absorbent core. Under these circumstances, it has been observed that the superabsorbent sodium polyacrylate polymer can draw in the alkaline liquid dye bleed, locking the fluid into the SAP acidic environment, and therefore chemically neutralizing the color shift normally observed with Phenol Red pH indicator at an alkaline pH.

In the first step S1002 of the method 1000, a pH indicating dye composition is prepared. In an embodiment at least one water-soluble pH indicating dye is combined with at least one additional water-soluble dye. The dyes are solubilized first in isopropyl alcohol, then diluted further with deionized water. One embodiment includes 2% by weight Phenol Red pH indicating dye, 2% by weight Acid Green 16 dye, 18% by weight isopropyl alcohol and 78% by weight deionized water.

Normally, urine is mildly acidic to neutral (pH 5-7). pH can change with diet, but extremes in urine pH beyond this range are more likely to be associated with disease (pH 7.5 to 8+). Advantageously, Phenol Red pH indicating dye provides a specific color transition at alkaline pH 7.5.

Phenol Red is a weak acid. In its acid state, it is yellow. In the presence of a base, it donates a proton and converts to its basic form that is red in color. Though, because the color transition from yellow to red is not consumer friendly, Acid Green 16 pH indicating dye is combined with the Phenol Red pH indicating dye to provide a different color shift—from bright green at acidic pH to bright purple at alkaline pH. Thus, it's worth noting that dyes other than Acid Green 16 may be combined with Phenol Red to deliver alternate color shifts. Further, it is not necessary for embodiments of the subject technology to include Phenol Red indicating dye either.

Nonetheless, the aforementioned pH indicating dye composition serves as an ingredient in a binder composition used to chemically bond nonwoven fibers. In this regard, a nonionic or anionic emulsion polymer and nonionic or anionic surfactant are combined with water at step S1004 then mixed with the pH indicating dye solution at step S1006 of the method 1000 to form a pH indicating binder composition. Thus in an embodiment of the subject technology, at step S1006, 67.02% by weight of water is blended with 0.31% by weight of Dow Polywet 700-D (70% active sodium dioctylsulfosuccinate in diethylene glycol), together with 23.64% by weight of Celanese Dur-o-Set Elite 22 (50% active vinyl acetate ethylene in water), 7.98 % by weight of premix water used to solubilize 0.10% ammonium chloride (100% active), and 0.95% by weight of the aforementioned pH indicating dye solution. However, numerous emulsion polymers and surfactants may be used so long as they are nonionic or anionic, and the final pH of the binder composition is acidic.

In this regard, at step S1006, the total dye concentration in the pH indicating binder composition is 0.038% active by weight, comprised of 0.019% active pH indicating Phenol Red dye, and 0.019% active Acid Green 16 dye.

Rayon and polyethylene fibers in a weight ratio of 50% to 50% are blended at step S1008, in a raw nonwoven fiber state. At step S1010, the fibers are immersed or otherwise saturated in the binder composition prepared at step S1006, to form a pH indicating nonwoven material 202. In alternative embodiments, various cellulose or cellulose-derived nonwoven fibers are viable aside from rayon and various synthetic fibers are viable aside from polyethylene. Further, various weight ratios between the fibers are viable.

At step S1012, the pH indicating nonwoven material 202 prepared via steps S1002 through S1010 is bonded to the aforementioned first tissue layer 204A, cellulose pulp layer 206, SAP layer 208, second tissue layer 204B, and backsheet 210 to produce a pH indicating absorbent pad in accordance with the subject technology.

It will be appreciated by those of ordinary skill in the pertinent art that the functions of several elements can, in alternative embodiments, be carried out by fewer elements, or a single element. Similarly, in some embodiments, any functional element can perform fewer, or different, operations than those described with respect to the illustrated embodiment. Also, functional elements shown as distinct for purposes of illustration can be incorporated within other functional elements in a particular embodiment.

While the subject technology has been described with respect to various embodiments, those skilled in the art will readily appreciate that various changes and/or modifications can be made to the subject technology without departing from the scope of the present disclosure.

What is claimed is:

1. A method of manufacturing a pH indicating absorbent pad comprising the steps of:
preparing a pH indicating dye formulation;
preparing a binder formulation having an emulsion polymer and surfactant solution; and the pH indicating dye formulation;
at least partially immersing or otherwise saturating a nonwoven fabric into the binder formulation, producing a pH indicating nonwoven material; and
bonding the pH indicating nonwoven material with an absorbent core to produce the pH indicating absorbent pad.

2. The method of claim 1, wherein the pH indicating dye formulation includes equal parts of Phenol Red dye and Acid Green 16 dye.

3. The method of claim 1, wherein the pH indicating dye formulation includes 18% by weight isopropyl alcohol and 78% by weight water.

4. The method of claim 1, wherein the pH indicating dye formulation includes 2% by weight Phenol Red dye, 2% by weight Acid Green 16 dye, 18% by weight isopropyl alcohol, and 78% by weight water

5. The method of claim 1, wherein the emulsion polymer and surfactant solution includes sodium dioctylsulfosuccinate and vinyl acetate ethylene.

6. The method of claim 1, wherein the emulsion polymer and surfactant solution includes 0.31% by weight Dow Polywet 700-D (sodium dioctylsulfosuccinate) and 23.64% by weight Celanese Dur-o-Set Elite 22 (vinyl acetate ethylene).

7. The method of claim 1, wherein the emulsion polymer and surfactant solution includes 67.02% by weight water, 7.98% by weight premix water, and 0.1 % by weight ammonium chloride.

8. The method of claim 1, wherein the emulsion polymer and surfactant solution includes 0.31% by weight Dow Polywet 700-D (sodium dioctylsulfosuccinate), 23.64% by weight Celanese Dur-o-Set Elite 22 (vinyl acetate ethylene). 67.02% by weight water, 7.98% by weight premix water, and 0.1% by weight ammonium chloride.

9. The method of claim 1, wherein the emulsion polymer and surfactant solution includes 70% active sodium dioctylsulfosuccinate in diethylene glycol.

10. The method of claim 1, wherein the emulsion polymer and surfactant solution includes 50% active vinyl acetate ethylene in water.

11. The method of claim 1, wherein the emulsion polymer and surfactant solution includes 0.31% by weight, 70% active sodium dioctylsulfosuccinate in diethylene glycol, and 23.64% by weight, 50% active vinyl acetate ethylene in water.

12. The method of claim 1, wherein the binder formulation includes 0.95% by weight pH indicating dye formulation.

13. The method of claim 1, wherein the anionic nonwoven fabric includes 50% rayon and 50% polyethylene fibers, and the method further comprises the steps of bonding the pH indicating nonwoven material and absorbent core with at least one tissue layer and a backsheet layer.

14. The method of claim 1, wherein the emulsion polymer and surfactant solution includes an acidic emulsion polymer and an anionic surfactant, and the nonwoven fabric is an anionic nonwoven fabric.

15. A method of manufacturing a pH indicating nonwoven material comprising the steps of:
preparing a pH indicating dye formulation;
preparing a binder formulation having an acidic emulsion polymer, an anionic or nonionic surfactant solution, and the pH indicating dye formulation; and
at least partially immersing or otherwise saturating an anionic nonwoven fabric into the binder formulation to produce the pH indicating nonwoven material.

16. The method of claim 15, wherein the emulsion polymer includes 0.31% by weight Dow Polywet 700-D (70% active sodium dioctylsulfosuccinate in diethylene glycol), and 23.64% by weight Celanese Dur-o-Set Elite 22 (50% active vinyl acetate ethylene in water).

17. The method of claim 15, wherein the pH indicating dye formulation includes 2% by weight Phenol Red dye, 2% by weight Acid Green 16 dye, 18% by weight isopropyl alcohol, and 78% by weight water, and the binder formulation includes 0.95% by weight of the pH indicating dye formulation.

18. The method of claim 15, wherein the anionic nonwoven fabric includes 50% rayon and 50% polyethylene fibers, the method further comprising the steps of bonding the pH indicating nonwoven material with an absorbent core having a pulp layer and a superabsorbent polymer, together with at least one tissue layer and a backsheet layer.

19. A method of manufacturing a pH indicating absorbent pad comprising the steps of:
preparing a pH indicating dye formulation;
preparing a binder formulation having an acidic emulsion polymer, an anionic or nonionic surfactant solution, and the pH indicating dye formulation;
at least partially immersing or otherwise saturating an anionic nonwoven fabric into the binder formulation, producing a pH indicating nonwoven material; and
bonding the pH indicating nonwoven material with an absorbent core having a pulp layer and a superabsorbent polymer layer to produce the pH indicating absorbent pad.

20. The method of claim 19, wherein the anionic nonwoven fabric includes 50% rayon and 50% polyethylene fibers, and further comprising the steps of bonding the pH indicating nonwoven material with the absorbent core with at least one tissue layer and a backsheet layer.
